(19) United States
(12) Patent Application Publication
(10) Pub. No.: US 2007/0063966 A1
(43) Pub. Date: Mar. 22, 2007

(54) Display device

(75) Inventors: Shu-Mei Chien, Taoyuan County (TW); Ko-Hsien Lee, Kaohsiung County (TW); Jian-Ming Lee, Taipei Hsien (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/509,666

(22) Filed: Aug. 25, 2006

(30) Foreign Application Priority Data
Sep. 5, 2005 (TW) 94130400

(51) Int. Cl. G09G 3/00

(52) U.S. Cl. 345/111

(57) ABSTRACT

A display device comprises a display unit and a base for supporting the display unit to locate at difference positions. The base comprises a first element moved between a first position and a second position, a first magnet-generator and two second magnet-generators disposed on the first element with respect to the first magnet-generator. As the second magnet-generator is inducted by the first magnet-generator, the first element is moved from the first position to the second position.

### BACKGROUND

The invention relates to a display device, and in particular to a display device automatically controlled at a desired position.

For large LCD TVs, the size and weight of a panel is correspondingly increased, thus, manual rotation of the panel to a desired position is difficult.

### SUMMARY

The invention provides a display device using magnetic force to rotate a display unit to a desired position.

The display device comprises a display unit and a base connected to the display unit. The display unit is supported and magnetically controlled by the base. The base comprises a first element connected to the display unit and moved between a first position and a second position, a first magnet-generator and a second magnet-generator disposed on the first element with respect to the first magnet-generator. As the second magnet-generator is inducted by the first magnet-generator, the first element is moved from the first position to the second position.

### DESCRIPTION OF THE DRAWINGS

The invention can be more fully understood by reading the subsequent detailed description and examples with references made to the accompanying drawings, wherein:

FIG. 1A is a perspective view of a display device (E) of the invention;

FIG. 1B is a perspective view of the display device (E) of the invention;

FIG. 2 is a partial section view of the display device (E) along a line (a-a) in FIG. 1A; and

FIG. 3 is a schematically exploded view of the display device (E) of FIG. 1A;

### DETAILED DESCRIPTION

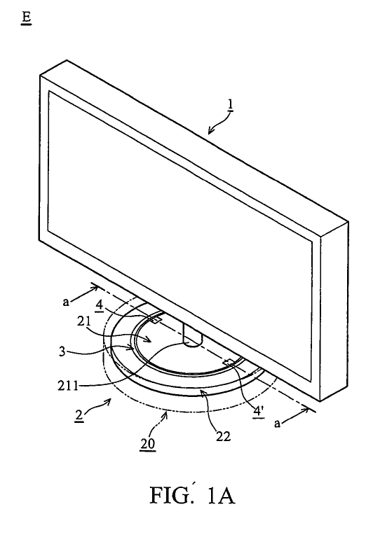

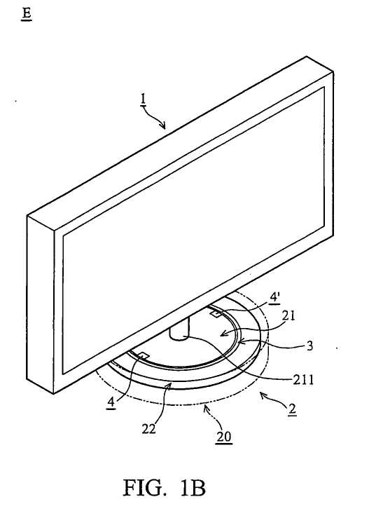

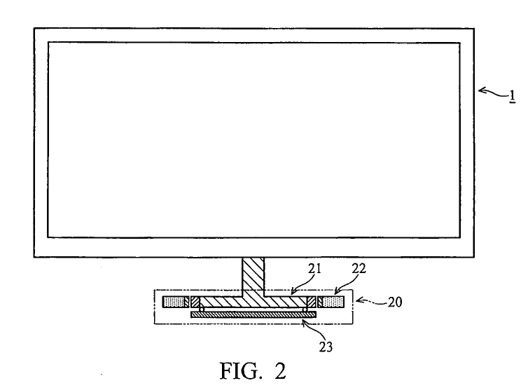

FIGS. 1A and 1B show a first and a second position of a display device E of the invention, respectively. FIG. 2 is a partial section view of the display device E along a line a-a in FIG. 1A. In this embodiment, the display device E is a liquid crystal display TV (LCD TV).

The display device E comprises a display unit 1 and a base 2 connected to the display unit 1. The display unit 1 is a liquid crystal display (LCD) supported and magnetically controlled by the base 2.

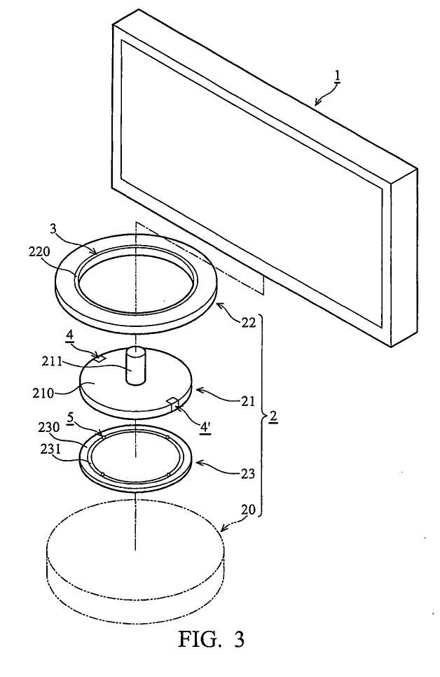

In FIG. 3, the base 2 comprises a housing 20 (in dotted line), a first element 21, a second element 22, a third element 23, a first magnet-generator 3, a pair of second magnet-generators 4/4′ and a plurality of rolling elements 5. The first magnet-generator 3 is preset as a predetermined magnetically positive or negative polarization.

The first element 21 comprises a rounded plate 210 and a post 211 extending from the plate 210 and connected to the display unit 1. The second element 22 is an annular ring having an inner part 220. The first magnet-generator 3 is divisionally disposed on the inner part 220 of the second element 22 with respect to the center of the post 211, and the second magnet-generators 4/4′ are disposed on both sides of the periphery of the first element 21 relative to the first magnet-generator 3. In the embodiment, the first magnet-generator 3 is a coil, and the second magnet-generator 4/4′ are two magnets with the same polarization. The first magnet-generator 3 is electronically connected to an excited device (not shown in Figs.).

The third element 23 is a disk having a surface 230 formed with an annular slot 231, and a corresponding slot (not shown in Figs.) formed on the first element 21 corresponds to the annular slot 231 of the third element 23. The rolling elements 5 such as balls disposed between third element 23 and the first element 21 are movably guided by the slot 231. As the third element 23 together with the rolling elements 5 are disposed between the first element 21 and the housing 20, the first element 21 contacting the rolling elements 5 is rotated relatively with respect to the third element 23.

The polarization of the first magnet-generator 3 is set as the same as the second magnet-generator 4 but opposite to the second magnet-generator 4′. As the first magnet-generator 3 having the predetermined polarization is electrically excited, the second magnet-generator 4/4′ is inducted by the first magnet-generator 3. Then, the first element 21 operating via the first magnet-generator 3 and the second magnet-generator 4/4′ is rotated clockwise, so that the display unit 1 can be rotated from the first position (FIG. 1A) to the second position (FIG. 1B). Thus, the rotation of the display unit 1 can be easily controlled and adjusted by the first magnet-generator 3.

Noted that the base 2 is enclosed in a TV box (not shown in Figs.), noise generated by the elements of the base 2 can be reduced. Further, the rotation of the display unit 1 can also be controlled by a remote (not shown in the Figs.).

While the invention has been described with respect to preferred embodiment, it is to be understood that the invention is not limited thereto the disclosed embodiments, but, on the contrary, is intended to accommodate various modifications and equivalent arrangements included within the spirit and scope of the appended claims.

What is claimed is:

1. A display device, comprising:
a display unit; and
a base comprising a first element connected to the display unit and moved between a first position and a second position, a first magnet-generator and a second magnet-generator disposed on the first element with respect to the first magnet-generator;
wherein the first element is moved from the first position to the second position as the second magnet-generator is inducted by the first magnet-generator.

2. The display device as claimed in claim 1, wherein the base further comprises a second element for receiving the first magnet-generator.

3. The display device as claimed in claim 1, wherein the base further comprises a third element for contacting the first element.

4. The display device as claimed in claim 3, wherein the base further comprises a plurality of rolling elements disposed between the first element and the third element.

5. The display device as claimed in claim 4, wherein the rolling elements are disposed on the third element.

6. The display device as claimed in claim 1, wherein the first magnet-generator comprises a coil.

7. The display device as claimed in claim 1, wherein the second magnet-generator comprises a magnet.

8. The display device as claimed in claim 1, wherein the display unit comprises a liquid crystal display.
